(19) United States
(12) Patent Application Publication
(10) Pub. No.: US 2024/0203417 A1
(43) Pub. Date: Jun. 20, 2024

(54) INTELLIGENT CAPTION EDGE COMPUTING

(71) Applicant: INTERNATIONAL BUSINESS MACHINES CORPORATION, ARMONK, NY (US)

(72) Inventors: Su Liu, Austin, TX (US); David Jason Hunt, Kirkwood, MO (US); NEIL DELIMA, Scarborough (CA); John Walicki, Ridgewood, NJ (US)

(21) Appl. No.: 18/066,365

(22) Filed: Dec. 15, 2022

(51) Int. Cl. G10L 15/26; H04L 65/403

(52) U.S. Cl. CPC G10L 15/26; H04L 65/403

(57) ABSTRACT

A method, computer program, and computer system are provided for real-time caption generation in an edge computing environment. Contexts related to one or more participants using a caption service in a web conference service are monitored. Personal characteristics associated with each of the participants are determined based on the monitored contexts. An edge device is selected from among a plurality of edge devices based on the determined personal characteristics. The selected edge device is configured to perform caption conversion a participant from among the participants in the web conference service. A lightweight user accent-oriented caption edge module associated with the selected edge device is customized for the participant. The customized lightweight user accent-oriented caption edge module is deployed to the selected edge device based on a corpus of captions associated with the user accent-oriented caption edge module most closely matching the determined personal characteristics.

### FIELD

This disclosure relates generally to field of edge computing, and more particularly to natural language processing through edge computing.

### BACKGROUND

Edge computing is a distributed computing framework that brings enterprise applications closer to data sources such as IoT devices or local edge servers. Specifically, in an edge computing environment, client data is processed at the periphery of the network, as close to the originating source as possible. This proximity to data at its source can deliver positive benefits, including faster insights, improved response times and better bandwidth availability.

### SUMMARY

Embodiments relate to a method, system, and computer readable medium for real-time caption generation in an edge computing environment. According to one aspect, a method for real-time caption generation in an edge computing environment is provided. The method may include monitoring contexts related to one or more participants using a caption service in a web conference service. Personal characteristics associated with each of the participants are determined based on the monitored contexts. An edge device is selected from among a plurality of edge devices based on the determined personal characteristics. The selected edge device is configured to perform caption conversion a participant from among the participants. A lightweight user accent-oriented caption edge module associated with the selected edge device is customized for the participant. The customized lightweight user accent-oriented caption edge module is deployed to the selected edge device based on a corpus of captions associated with the user accent-oriented caption edge module most closely matching the determined personal characteristics.

According to another aspect, a computer system for real-time caption generation in an edge computing environment is provided. The computer system may include one or more processors, one or more computer-readable memories, one or more computer-readable tangible storage devices, and program instructions stored on at least one of the one or more storage devices for execution by at least one of the one or more processors via at least one of the one or more memories, whereby the computer system is capable of performing a method. The method may include monitoring contexts related to one or more participants using a caption service in a web conference service. Personal characteristics associated with each of the participants are determined based on the monitored contexts. An edge device is selected from among a plurality of edge devices based on the determined personal characteristics. The selected edge device is configured to perform caption conversion a participant from among the participants. A lightweight user accent-oriented caption edge module associated with the selected edge device is customized for the participant. The customized lightweight user accent-oriented caption edge module is deployed to the selected edge device based on a corpus of captions associated with the user accent-oriented caption edge module most closely matching the determined personal characteristics.

According to yet another aspect, a computer readable medium for real-time caption generation in an edge computing environment is provided. The computer readable medium may include one or more computer-readable storage devices and program instructions stored on at least one of the one or more tangible storage devices, the program instructions executable by a processor. The program instructions are executable by a processor for performing a method that may accordingly include monitoring contexts related to one or more participants using a caption service in a web conference service. Personal characteristics associated with each of the participants are determined based on the monitored contexts. An edge device is selected from among a plurality of edge devices based on the determined personal characteristics. The selected edge device is configured to perform caption conversion a participant from among the participants. A lightweight user accent-oriented caption edge module associated with the selected edge device is customized for the participant. The customized lightweight user accent-oriented caption edge module is deployed to the selected edge device based on a corpus of captions associated with the user accent-oriented caption edge module most closely matching the determined personal characteristics.

### BRIEF DESCRIPTION OF THE DRAWINGS

These and other objects, features and advantages will become apparent from the following detailed description of illustrative embodiments, which is to be read in connection with the accompanying drawings. The various features of the drawings are not to scale as the illustrations are for clarity in facilitating the understanding of one skilled in the art in conjunction with the detailed description. In the drawings:

FIG. 1 illustrates a networked computer environment according to at least one embodiment;

FIG. 2 illustrates a networked computer environment according to at least one embodiment

FIG. 3 is a block diagram of a system for real-time caption generation in an edge computing environment, according to at least one embodiment;

FIG. 4 is a block diagram of an edge server in an edge computing environment for real-time caption generation, according to at least one embodiment;

FIG. 5 is an operational flowchart illustrating the steps carried out by a program that performs real-time caption generation in an edge computing environment, according to at least one embodiment; and

FIG. 6 is a block diagram of internal and external components of computers and servers depicted in FIG. 1 according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. Those structures and methods may, however, be embodied in many different forms and should not be construed as limited to the exemplary embodiments set forth herein. Rather, these exemplary embodiments are provided so that this disclosure will be thorough and complete and will fully convey the scope to those skilled in the art. In the description, details of well-known features and techniques may be omitted to avoid unnecessarily obscuring the presented embodiments.

Embodiments relate generally to the field of edge computing, and more particularly to natural language processing through edge computing. The following described exemplary embodiments provide a system, method, and computer program to, among other things, generate captions in real-time based on identifying an edge device that best corresponds to a user from among a plurality of users for whom captions may be generated. Therefore, some embodiments have the capacity to improve the field of computing by allowing for the identification of a user based on a physical characteristic of the user, such as a fingerprint, iris, face, voice, or handwriting. Moreover, some embodiments have the capacity to improve the field of telecommunications by allowing for improved integration of transcription and translation of capabilities in telecommunications software applications.

As previously described, edge computing is a distributed computing framework that brings enterprise applications closer to data sources such as IoT devices or local edge servers. Specifically, in an edge computing environment, client data is processed at the periphery of the network, as close to the originating source as possible. This proximity to data at its source can deliver positive benefits, including faster insights, improved response times and better bandwidth availability.

As edge computing has become more widespread, the demand for captioning and subtitle generation has accelerated in teleconferencing, such as video web conferencing. This demand is driven by factors such as the increased consumption of digital streaming video, the growth of online conferencing platforms that connect globally diverse communities today, and accessibility legislation requiring or suggesting provision of captioning services, such as the Americans with Disabilities Act. Many web conference services, therefore, may need real-time caption generation. Recently, much emphasis has been placed on minimization of bias and unintended collection of personal data in AI system associated with developing transcription and translation models and real time analysis. Generic speech recognition models do not account for globally diverse communities with different accents or manners of speech that communicate with each other or consume content in another language. Moreover, the content, tone, and characteristics of a speaker's voice may contain personal information such as cues to a biometric identity, personality, emotions, or the like.

Ultimately, speech information is personal data, and different regions/states have different laws on personal information processes. Real-time speech-to-text based captioning and subtitle generation can be performed on a centralized server, and modern speech-to-text applications have been customized for different user groups, accents, geolocation, etc. for increasing accuracy. For example, different applications may be better suited to generating captions for U.S.-English, U.K.-English, and Chinese-English accents. However, because of network bandwidth and resource-intensive natural language processing, captions may be lost or suffer lag because of computer performance limitations and computer network issues. Additionally, privacy concerns may arise due to the biometric nature of speech data. It may be advantageous, therefore, to perform subtitle and caption generation in an edge computing environment to distribute the computational resource load across several devices in the edge computing environment while maintaining user privacy.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The following described exemplary embodiments provide a system, method and computer program that may enable real-time analysis of personal characteristics, such as accent analysis, to configure and deploy a lightweight, customized, user-accent oriented caption edge module to a selected edge device for enhancing caption generation quality and protecting user privacy.

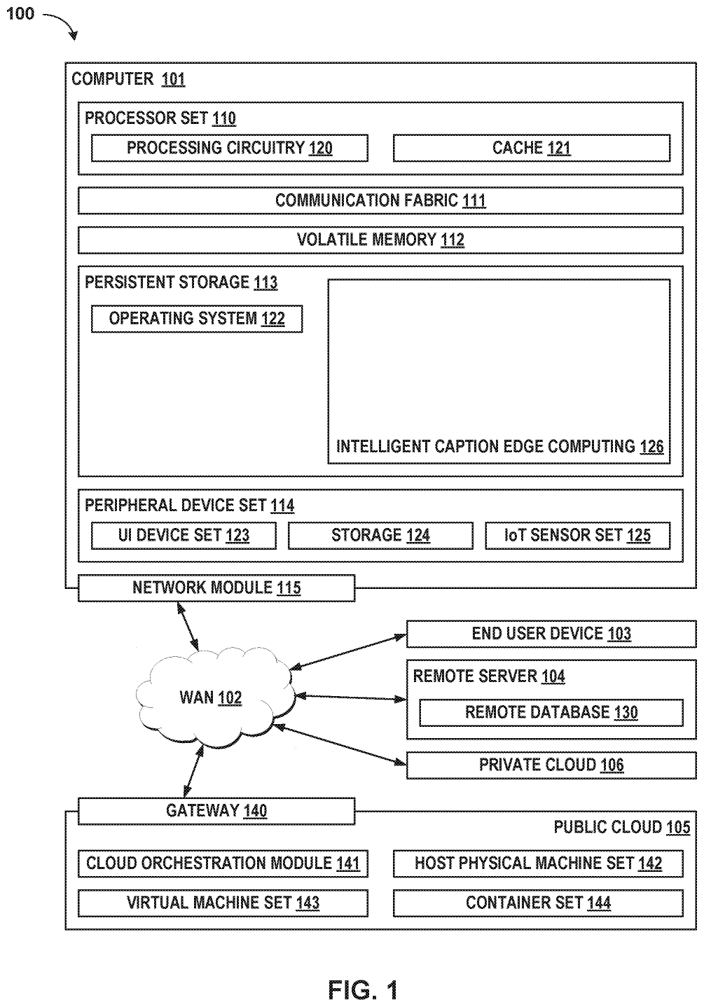

Referring now to FIG. 1, Computing environment 100 contains an example of an environment for the execution of at least some of the computer code involved in performing the inventive methods, such as Intelligent Caption Edge Computing (ICEC) 126. In addition to Intelligent Caption Edge Computing 126, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and Intelligent Caption Edge Computing 126, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in Intelligent Caption Edge Computing 126 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in Intelligent Caption Edge Computing 126 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer 11rogram 11e, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

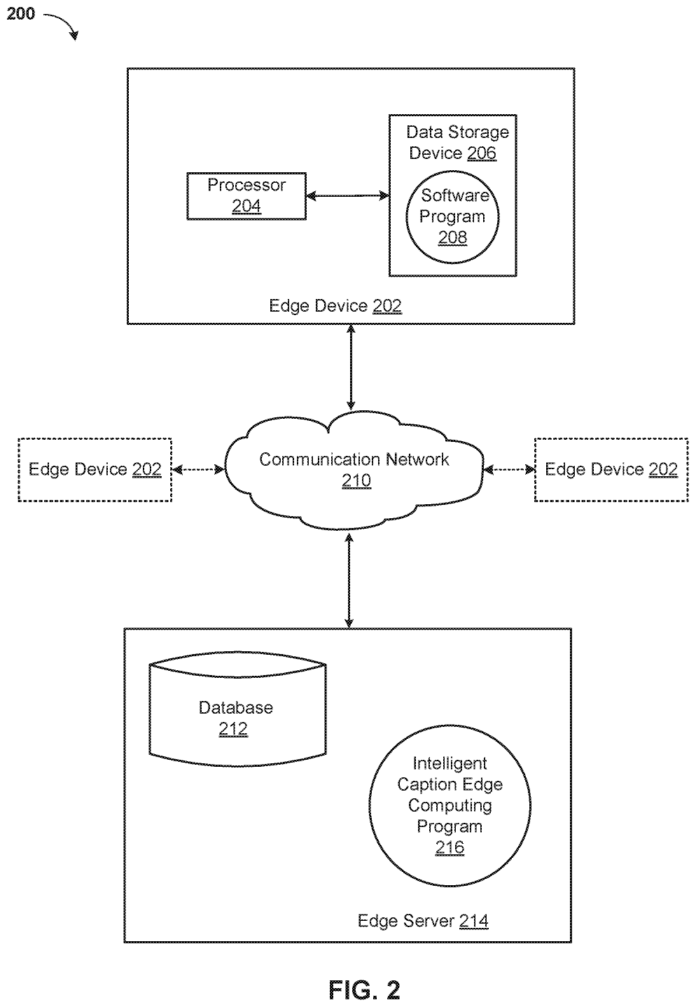

Referring now to FIG. 2, a functional block diagram of a networked computer environment illustrating a caption generation system 200 (hereinafter “system”) for real-time caption generation in an edge computing environment. It should be appreciated that FIG. 2 provides only an illustration of one implementation and does not imply any limitations with regard to the environments in which different embodiments may be implemented. Many modifications to the depicted environments may be made based on design and implementation requirements.

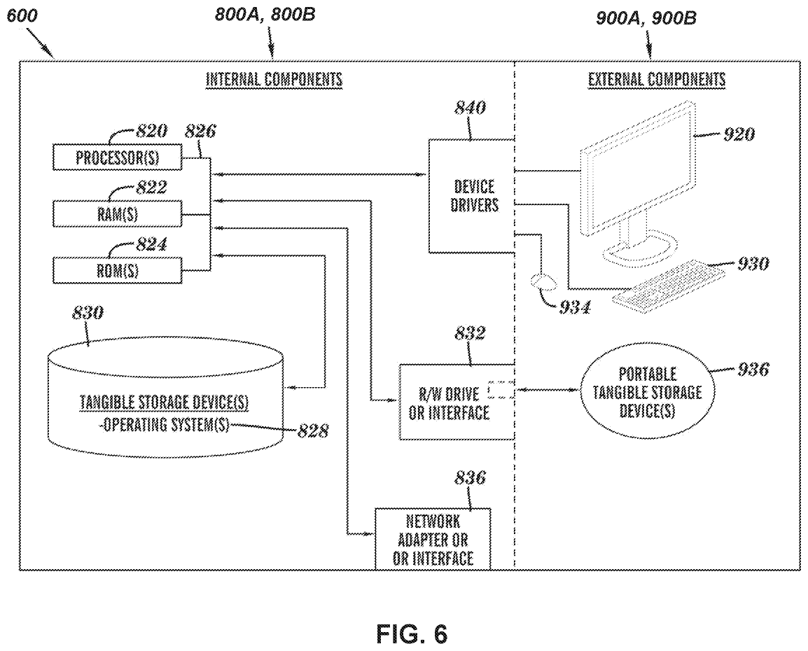

The system 200 may include one or more edge devices 202 and an edge server 214. The edge devices 202 may communicate with the edge server 214 via a communication network 210 (hereinafter “network”). The edge devices 202 may each include a processor 204 and a software program 208 that is stored on a data storage device 206 and is enabled to interface with a user and communicate with the edge server 214. As will be discussed below with reference to FIG. 6, the edge devices 202 may include internal components 800A and external components 900A, respectively, and the edge server 214 may include internal components 800B and external components 900B, respectively. The edge devices 202 may be, for example, a mobile device, a telephone, a personal digital assistant, a netbook, a laptop computer, a tablet computer, a desktop computer, or any type of computing devices capable of running a program, accessing a network, and accessing a database.

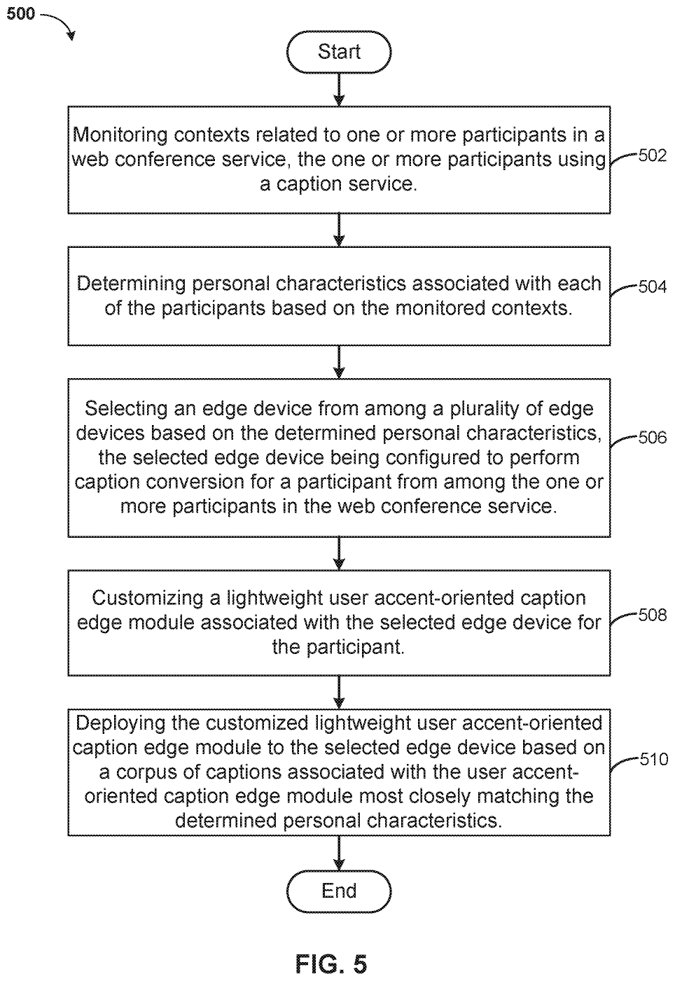

The edge server 214, which may be used for real-time caption generation in an edge computing environment is enabled to run an Intelligent Caption Edge Computing Program 216 (hereinafter “program”) that may interact with a database 212. The Intelligent Caption Edge Computing Program is explained in more detail below with respect to FIG. 5. In one embodiment, the edge devices 202 may operate as an input device including a user interface while the program 216 may run primarily on edge server 214. In an alternative embodiment, the program 216 may run primarily on the one or more edge devices 202 while the edge server 214 may be used for processing and storage of data used by the program 216. It should be noted that the 12rogramm 216 may be a standalone program or may be integrated into a larger Caption Edge Computing program.

It should be noted, however, that processing for the program 216 may, in some instances be shared amongst the edge devices 202 and the edge server 214 in any ratio. In another embodiment, the program 216 may operate on more than one computer, server computer, or some combination of computers and server computers, for example, a plurality of edge devices 202 communicating across the network 210 with a single edge server 214. In another embodiment, for example, the program 216 may operate on a plurality of edge servers 214 communicating across the network 210 with a plurality of client computers. Alternatively, the program may operate on a network server communicating across the network with a server and a plurality of client computers.

The network 210 may include wired connections, wireless connections, fiber optic connections, or some combination thereof. In general, the network 210 can be any combination of connections and protocols that will support communications between the edge devices 202 and the edge server 214. The network 210 may include various types of networks, such as, for example, a local area network (LAN), a wide area network (WAN) such as the Internet, a telecommunication network such as the Public Switched Telephone Network (PSTN), a wireless network, a public switched network, a satellite network, a cellular network (e.g., a fifth generation (5G) network, a long-term evolution (LTE) network, a third generation (3G) network, a code division multiple access (CDMA) network, etc.), a public land mobile network (PLMN), a private network, an ad hoc network, an intranet, a fiber optic-based network, or the like, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of system 200 may perform one or more functions described as being performed by another set of devices of system 200.

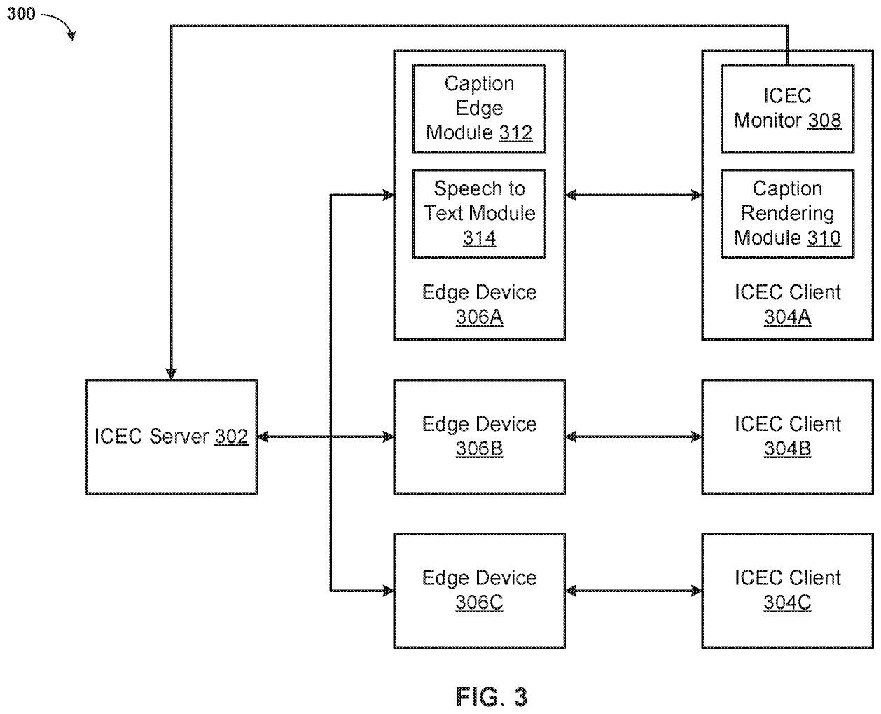

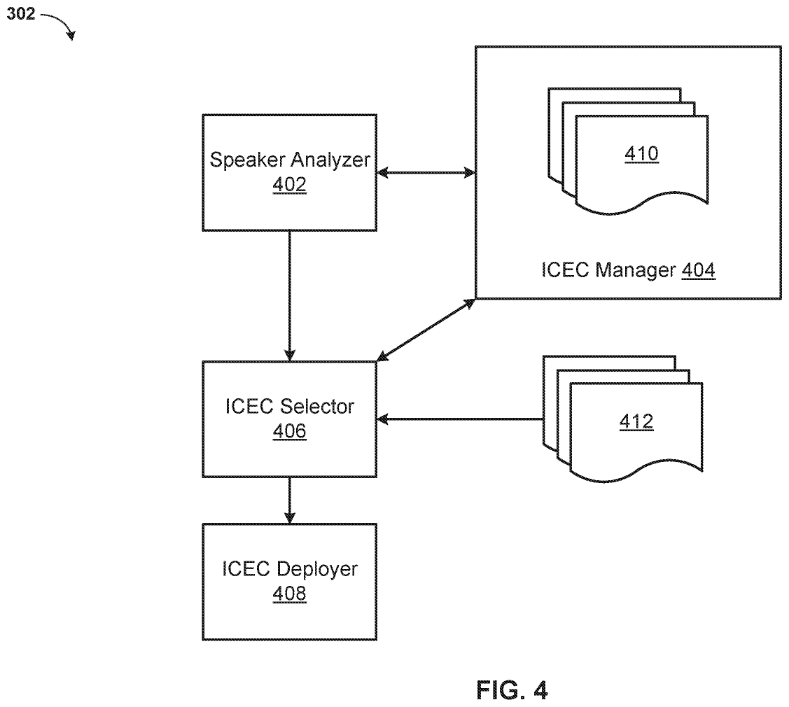

Referring now to FIG. 3, a caption generation edge computing system 300 is depicted according to one or more embodiments. The caption generation edge computing system 300 may include, among other things, an intelligent caption edge computing (ICEC) server 302, ICEC clients 304A-C, and edge devices 306A-C. For ease of description, three ICEC clients 304A-C and three edge devices 306A-C are depicted. It may be appreciated, however, that substantially any number of edge devices and ICEC clients may be deployed. The ICEC server 302 will be described in further detail in the description for FIG. 4.

The ICEC clients 304A-C may include, among other things, an ICEC monitor 308 and a caption rendering module 310. For ease of description, only one ICEC monitor 308 and one caption rendering module 310 are depicted in FIG. 3. It may be appreciated, however, that each of the ICEC clients 304A-C may include an ICEC monitor 308 and a caption rendering module 310, and that any description of the ICEC client 304A substantially applies to ICEC clients 304B and 304C. By way of example and not of limitation, the ICEC client 304A may be associated with a speaker from among a group of speakers in a web conference. For example, the ICEC client 304A may be, for example, a computer or mobile device by which a speaker accesses the web conference. The ICEC monitor 308 may identify that the speaker associated with the ICEC client 304A is speaking. The ICEC monitor 308 may transmit data associated with the speaker to the ICEC speaker 302. This data may include, among other things, personal characteristics, such as a location of the user, a native language of the user, a secondary language of a user, and a distance from an edge device from among the edge devices 306A-C. As will be discussed in further detail below, the caption rendering module 310 may display caption data of other speakers to the speaker associated with the ICEC client 304A.

The edge devices 306A-C may include, among other things, a caption edge module 312 and a speech to text module 314. For ease of description, only one caption edge module 312 and speech to text module 314 are depicted in FIG. 3. It may be appreciated, however, that each of the edge devices 306A-C may include a caption edge module 312 and a speech to text module 314, and that any description of edge device 306A substantially applies to edge devices 306B and 306C. The edge device 306A may be assigned by the ICEC server 302 to process speech to text data associated with a particular speaker, such as, for example, the speaker associated with the ICEC client 304A. The caption edge module 312 may define a data structure for saving and tracking each speaker or participant in a web conference meeting using ICEC data that may include, among other things, an application ID, an edge device ID, an accent speech-to-text module, a timestamp, and a determination whether a speaker is speaking. The speech to text module 314 may convert speech associated with the speaker or participant to text based on the ICEC data associated with the caption edge module 312.

Referring now to FIG. 4, an ICEC server 302, as depicted in FIG. 3, is depicted according to one or more embodiments. The ICEC server 302 may include, among other things, a speaker analyzer 402, a ICEC manager 404, an ICEC selector 406, and an ICEC deployer 408.

The speaker analyzer 402 may receive the data transmitted by the ICEC monitor 308 (FIG. 3). The speaker analyzer 402 may determine a participant's personal characteristics, such as location, native language, and secondary language. This may be performed through profile-based analysis or context-based analysis. The context-based analysis may include, among other things.

The ICEC manager 404 may maintain and update user caption conversion service profile data 410 according to an analyzed user's personal characteristics, such as location, native language, secondary language, etc. Such maintenance and updating may be performed in real-time.

The ICEC selector 406 may access data 412 that may include, among other things, one or more available accent modules and data associated with the edge devices 306 A-C. The ICEC selector 406, therefore, may use the caption service profiles from the ICEC manager 404 to select an appropriate accent module for best determining an edge device from among accent modules within the data 412 for generating captions for the user. Therefore, the ICEC selector 406 may select an appropriate accent module for generating captions to a specific user.

The ICEC deployer 408 may deploy a lightweight, customized, user accent-oriented caption edge module 312 (FIG. 3) on an edge device 306A (FIG. 3) from among the edge devices 306A-C (FIG. 3). The ICEC deployer may also cause the caption service to be provided to the user and for the caption service to display the captions on a device associated with the user based on the corpus of captions of the selected caption service most closely matching the personal characteristics of the user and, therefore, being the best caption service for the specific user from among the available caption services.

Referring now to FIG. 5, an operational flowchart illustrating the steps of a method 500 carried out by a program that generates real-time captions of participants in a web conference through an edge computing environment is depicted. The method 500 may be described with the aid of the exemplary embodiments of FIGS. 1-4.

At 502, the method 500 may include monitoring contexts related to one or more participants in a web conference service, the one or more participants using a caption service. A framework to maintain and customize edge generation may be defined based on dynamically monitoring the contexts. In operation, the ICEC monitor 308 (FIG. 3) on the ICEC Client 304A (FIG. 3) may monitor contexts associated with a user of the ICEC Client 304A to determine whether the user needs or may need captions to be displayed on the ICEC Client 304A.

At 504, the method 500 may include determining personal characteristics associated with each of the participants based on the monitored contexts. The personal characteristics correspond to location, native language, and secondary language. The personal characteristics may be used to maintaining and updating user caption conversion service profiles for the participants. In operation, the speaker analyzer 402 (FIG. 4) on the ICEC Server 302 (FIG. 3) may determine characteristics associated with the user of the ICEC Client 304A (FIG. 3). The personal characteristics may be used to update the user caption conversion service profile data 410 (FIG. 4) by the ICEC Manager 404 (FIG. 4).

At 506, the method 500 may include selecting an edge device from among a plurality of edge devices based on the determined personal characteristics. The selected edge device is configured to perform caption conversion for a participant from among the one or more participants in the web conference service. In operation, the ICEC Selector 406 (FIG. 4) on the Server 302 (FIG. 3) may select an edge device 306A (FIG. 3) from among the edge devices 306A-C (FIG. 3) based on the user caption conversion service profile data 410 (FIG. 4) maintained and updated by the ICEC Manager 404 (FIG. 4) in order to assign the ICEC Client 304A (FIG. 3) to the edge device 306A for caption generation based on personal characteristics of the user of the ICEC Client 304A.

At 508, the method 500 may include customizing a lightweight user accent-oriented caption edge module associated with the selected edge device for the participant. A data structure may be defined for saving and tracking the caption service associated with each participant. In operation, the ICEC Deployer 408 (FIG. 4) may cause the caption edge module 312 (FIG. 3) on the edge device 306A (FIG. 3) to be customized for the user of the ICEC Client 304A (FIG. 3). According, the speech to text module 314 (FIG. 3) may receive the configuration information from the caption edge module 312 for caption generation based on converting speech to text.

At 510, the method 500 may include deploying the customized lightweight user accent-oriented caption edge module to the selected edge device based on a corpus of captions associated with the user accent-oriented caption edge module most closely matching the determined personal characteristics. The caption edge module may be used to provide a caption conversion service from the deployed edge device to the participant from among the one or more participants and may cause the provided caption conversion service to display captions on one or more devices associated with the participant from among the one or more participants. In operation, the captions generated by the speech to text module 314 (FIG. 3) may be caused to be displayed to the user of the ICEC Client 304A (FIG. 3) by the caption rendering module 310 (FIG. 3) located on the ICEC Client 304A.

It may be appreciated that FIG. 5 provides only an illustration of one implementation and does not imply any limitations with regard to how different embodiments may be implemented. Many modifications to the depicted environments may be made based on design and implementation requirements.

FIG. 6 is a block diagram 600 of internal and external components of computers depicted in FIG. 1 in accordance with an illustrative embodiment. It should be appreciated that FIG. 6 provides only an illustration of one implementation and does not imply any limitations with regard to the environments in which different embodiments may be implemented. Many modifications to the depicted environments may be made based on design and implementation requirements.

Edge devices 202 (FIG. 2) and edge server 214 (FIG. 2) may include respective sets of internal components 800A,B and external components 900A,B illustrated in FIG. 6. Each of the sets of internal components 800 include one or more processors 820, one or more computer-readable RAMs 822 and one or more computer-readable ROMs 824 on one or more buses 826, one or more operating systems 828, and one or more computer-readable tangible storage devices 830.

Processor 820 is implemented in hardware, firmware, or a combination of hardware and software. Processor 820 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 820 includes one or more processors capable of being programmed to perform a function. The one or more buses 826 include a component that permits communication among the internal components 800A,B.

The one or more operating systems 828, the software program 108 (FIG. 2) and the Intelligent Caption Edge Computing Program 216 (FIG. 2) on edge server 214 (FIG. 2) are stored on one or more of the respective computer-readable tangible storage devices 830 for execution by one or more of the respective processors 820 via one or more of the respective RAMs 822 (which typically include cache memory). In the embodiment illustrated in FIG. 6, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory, an optical disk, a magneto-optic disk, a solid-state disk, a compact disc (CD), a digital versatile disc (DVD), a floppy disk, a magnetic tape, and/or another type of non-transitory computer-readable tangible storage device that can store a computer program and digital information.

Each set of internal components 800A,B also includes a R/W drive or interface 832 to read from and write to one or more portable computer-readable tangible storage devices 936 such as a CD-ROM, DVD, memory stick, magnetic tape, magnetic disk, optical disk or semiconductor storage device. A software program, such as the software program 108 (FIG. 2) and the Intelligent Caption Edge Computing Program 216 (FIG. 2) can be stored on one or more of the respective portable computer-readable tangible storage devices 936, read via the respective R/W drive or interface 832 and loaded into the respective computer-readable tangible storage device 830.

Each set of internal components 800A,B also includes network adapters or interfaces 836 such as a TCP/IP adapter cards; wireless Wi-Fi interface cards; or 3G, 4G, or 5G wireless interface cards or other wired or wireless communication links. The software program 108 (FIG. 2) and the Intelligent Caption Edge Computing Program 216 (FIG. 2) on the edge server 214 (FIG. 2) can be downloaded to the edge devices 202 (FIG. 2) and edge server 214 from an external computer via a network (for example, the Internet, a local area network or other, wide area network) and respective network adapters or interfaces 836. From the network adapters or interfaces 836, the software program 108 and the Intelligent Caption Edge Computing Program 216 on the edge server 214 are loaded into the respective computer-readable tangible storage device 830. The network may comprise copper wires, optical fibers, wireless transmission, routers, firewalls, switches, gateway computers and/or edge servers.

Each of the sets of external components 900A,B can include a computer display monitor 920, a keyboard 930, and a computer mouse 934. External components 900A,B can also include touch screens, virtual keyboards, touch pads, pointing devices, and other human interface devices. Each of the sets of internal components 800A,B also includes device drivers 840 to interface to computer display monitor 920, keyboard 930 and computer mouse 934. The device drivers 840, R/W drive or interface 832 and network adapter or interface 836 comprise hardware and software (stored in computer-readable tangible storage device 830 and/or ROM 824).

Some embodiments may relate to a system, a method, and/or a computer readable medium at any possible technical detail level of integration. The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

No element, act, or instruction used herein should be construed as critical or essential unless explicitly described as such. Also, as used herein, the articles “a” and “an” are intended to include one or more items and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

The descriptions of the various aspects and embodiments have been presented for purposes of illustration but are not intended to be exhaustive or limited to the embodiments disclosed. Even though combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of real-time caption generation in an edge computing environment, executable by a processor, comprising:
monitoring contexts related to one or more participants in a web conference service, the one or more participants using a caption service;
determining personal characteristics associated with each of the participants based on the monitored contexts;
selecting an edge device from among a plurality of edge devices based on the determined personal characteristics, the selected edge device being configured to perform caption conversion for a participant from among the one or more participants in the web conference service;
customizing a lightweight user accent-oriented caption edge module associated with the selected edge device for the participant; and
deploying the customized lightweight user accent-oriented caption edge module to the selected edge device based on a corpus of captions associated with the user accent-oriented caption edge module most closely matching the determined personal characteristics.

2. The method of claim 1, further comprising providing a caption conversion service from the deployed edge device to the participant from among the one or more participants.

3. The method of claim 2, further comprising causing the provided caption conversion service to display captions on one or more devices associated with the participant from among the one or more participants.

4. The method of claim 1, further comprising defining a framework to maintain and customize edge generation based on dynamically monitoring the contexts.

5. The method of claim 4, further comprising defining a data structure for saving and tracking the caption service associated with each participant.

6. The method of claim 4, further comprising maintaining and updating user caption conversion service profiles according to the determined personal characteristics.

7. The method of claim 1, wherein the personal characteristics correspond to one or more from among location, native language, secondary language.

8. A computer system for real-time caption generation in an edge computing environment, the computer system comprising:
one or more computer-readable non-transitory storage media configured to store computer program code; and
one or more computer processors configured to access said computer program code and operate as instructed by said computer program code, said computer program code including:
monitoring code configured to cause the one or more computer processors to monitor contexts related to one or more participants in a web conference service, the one or more participants using a caption service;
determining code configured to cause the one or more computer processors to determine personal characteristics associated with each of the participants based on the monitored contexts;
selecting code configured to cause the one or more computer processors to select an edge device from among a plurality of edge devices based on the determined personal characteristics, the selected edge device being configured to perform caption conversion for a participants from among the one or more participants in the web conference service;
customizing code configured to cause the one or more computer processors to customize a lightweight user accent-oriented caption edge module associated with the selected edge device for the participant; and
deploying code configured to cause the one or more computer processors to deploy the customized lightweight user accent-oriented caption edge module to the selected edge device based on a corpus of captions associated with the user accent-oriented caption edge module most closely matching the determined personal characteristics.

9. The computer system of claim 8, further comprising providing code configured to cause the one or more computer processors to provide a caption conversion service from the deployed edge device to the participant from among the one or more participants.

10. The computer system of claim 9, further comprising causing code configured to cause the one or more computer processors to cause the provided caption conversion service to display captions on one or more devices associated with the participant from among the one or more participants.

11. The computer system of claim 8, further comprising defining code configured to cause the one or more computer processors to define a framework to maintain and customize edge generation based on dynamically monitoring the contexts.

12. The computer system of claim 11, further comprising defining code configured to cause the one or more computer processors to define a data structure for saving and tracking the caption service associated with each participant.

13. The computer system of claim 11, further comprising respective maintaining and updating code configured to cause the one or more computer processors to maintain and update user caption conversion service profiles according to the determined personal characteristics.

14. The computer system of claim 8, wherein the personal characteristics correspond to one or more from among location, native language, secondary language.

15. A non-transitory computer readable medium having stored thereon a computer program for real-time caption generation in an edge computing environment, the computer program configured to cause one or more computer processors to:
monitor contexts related to one or more participants in a web conference service, the one or more participants using a caption service;
determine personal characteristics associated with each of the participants based on the monitored contexts;
select an edge device from among a plurality of edge devices based on the determined personal characteristics, the selected edge device being configured to perform caption conversion for a participant from among the one or more participants in the web conference service;
customize a lightweight user accent-oriented caption edge module associated with the selected edge device to the participant; and
deploy the customized lightweight user accent-oriented caption edge module to the selected edge device based on a corpus of captions associated with the user accent-oriented caption edge module most closely matching the determined personal characteristics.

16. The computer readable medium of claim 15, wherein the computer program is further configured to cause the one or more computer processors to provide a caption conversion service from the deployed edge device to the participant from among the one or more participants.

17. The computer readable medium of claim 16, wherein the computer program is further configured to cause the one or more computer processors to cause the provided caption conversion service to display captions on one or more devices associated with the participant from among the one or more participants.

18. The computer readable medium of claim 15, wherein the computer program is further configured to cause the one or more computer processors to define a framework to maintain and customize edge generation based on dynamically monitoring the contexts.

19. The computer readable medium of claim 18, wherein the computer program is further configured to cause the one or more computer processors to define a data structure for saving and tracking the caption service associated with each participant.

20. The computer readable medium of claim 18, wherein the computer program is further configured to cause the one or more computer processors to maintain and update user caption conversion service profiles according to the determined personal characteristics.
